(19) United States
(12) Patent Application Publication
(10) Pub. No.: US 2016/0325449 A1
(43) Pub. Date: Nov. 10, 2016

(54) SLITTING APPARATUS AND METHOD FOR PRODUCING SEPARATOR ROLL

(71) Applicant: SUMITOMO CHEMICAL COMPANY, LIMITED, Chuo-ku, Tokyo (JP)

(72) Inventors: Kiyomu NOMURA, Niihama-shi (JP); Tatsuya KATAOKA, Niihama-shi (JP)

(73) Assignee: SUMITOMO CHEMICAL COMPANY, LIMITED, Chuo-ku, Tokyo (JP)

(21) Appl. No.: 14/780,593

(22) PCT Filed: May 26, 2015
(86) PCT No.: PCT/JP2015/065012

§ 371 Date: Sep. 28, 2015

(30) Foreign Application Priority Data
Dec. 25, 2014 (JP) 2014-263596

(51) Int. Cl. B26D 1/02; B26D 7/26; B26D 3/00; H01M 10/0525; B65H 20/02; B65H 35/02; H01M 2/14; B26D 1/03; B65H 18/26

(52) U.S. Cl. CPC B26D 1/025; B26D 1/035; B26D 7/2614; B26D 3/00; B65H 18/26; B65H 20/02; B65H 35/02; H01M 2/145; H01M 10/0525

(57) ABSTRACT

A wrinkle or misaligned winding caused in a separator roll is inhibited. A slitting apparatus (6) includes (i) a first touch roller (81U) whose position is changed in accordance with a change in outer diameter of a first separator roll (12U), which is formed on a core (u), so as to press the first separator (12a) onto a take-up surface of the first separator roll and (ii) a first take-up assisting roller (83U) which conveys the first separator immediately before the first touch roller and whose position is changed in accordance with positional change of the first touch roller.

### TECHNICAL FIELD

The present invention relates to a slitting apparatus for slitting a separator that is used in a battery such as a lithium-ion battery.

### BACKGROUND ART

As the slitting apparatus, for example, a slitting apparatus disclosed in Patent Literature 1 is known. The technique disclosed in Patent Literature 1 is aimed at providing a method for slitting a battery separator while hardly causing defects such as a pore and a rip in a slitting step. In view of this, the technique disclosed in Patent Literature 1 focuses on tension applied to the separator after being slit.

### CITATION LIST

### Patent Literature

### [Patent Literature 1]

Japanese Patent Application Publication Tokukai No. 2002-273684 (Publication date: Sep. 25, 2002)

### SUMMARY OF INVENTION

### Technical Problem

A battery separator is supplied to a battery production process in a form of a roll obtained by winding the slit separator on a core. In the battery production process, the separator wound off from the roll is to be laminated with a positive electrode film and a negative electrode film which are similarly and separately wound off from respective rolls.

However, in a case where a separator is wound off from a roll in which the separator has been wound up with a wrinkle or misaligned winding, the separator thus wound off is more likely to meander. In such a case where the separator meanders, a defect is caused in lamination with the positive electrode film and the negative electrode film. Under the circumstances, the roll of the separator is highly demanded to involve less wrinkles and less misaligned winding.

Note that the positive electrode film and the negative electrode film are also demanded to involve less wrinkles and less misaligned winding but the demand is particularly high for the separator. This is because of reasons below: that is, in a process of producing the separator, a stretching process is carried out, and therefore a film thickness is more likely to be uneven, and accordingly the unevenness in film thickness may cause a wrinkle and misaligned winding. Moreover, the separator which is porous is soft, and therefore a wrinkle is more likely to occur.

As above described, the technique disclosed in Patent Literature 1 focuses on tension applied to the separator after the slitting in order to hardly causing defects such as a pore and a rip in a slitting step, and Patent Literature 1 does not disclose a measure to inhibit a wrinkle and misaligned winding.

The present invention is accomplished in view of the problems, and its object is to inhibit a wrinkle or misaligned winding that is caused when a separator after being slit is wound.

### Solution to Problem

A slitting apparatus in accordance with an aspect of the present invention includes a slitting section for slitting an original sheet of a battery separator in a lengthwise direction so as to divide the original sheet into a plurality of separators; a take-up section for winding one of the plurality of separators on a core; a touch roller whose position is changed in accordance with a change in outer diameter of a separator roll so as to press the one of the plurality of separators onto a take-up surface of the separator roll which has been formed on the core; and a take-up assisting roller for conveying the one of the plurality of separators immediately before the touch roller, a position of the take-up assisting roller being changed in accordance with positional change of the touch roller.

A slitting apparatus in accordance with an aspect of the present invention includes a slitting section for slitting an original sheet of a battery separator in a lengthwise direction so as to divide the original sheet into a plurality of separators; a take-up section for winding one of the plurality of separators on a core; a touch roller whose position is changed in accordance with a change in outer diameter of a separator roll so as to press the one of the plurality of separators onto a take-up surface of the separator roll which has been formed on the core; a take-up assisting roller for conveying the one of the plurality of separators immediately before the touch roller; and a roller attaching section to which the take-up assisting roller is attached, the roller attaching section being provided so that a distance between the touch roller and the take-up assisting roller is selectable from a plurality of distances.

A slitting apparatus in accordance with an aspect of the present invention includes a slitting section for slitting an original sheet of a battery separator in a lengthwise direction so as to divide the original sheet into a plurality of separators; a take-up section having one (1) rotation shaft for holding a plurality of cores on which the respective plurality of separators are wound; and a plurality of touch rollers which are provided for the one (1) rotation shaft and whose positions are separately changed in accordance with changes in outer diameter of a plurality of separator rolls, which have been formed on the respective plurality of cores, so as to press the plurality of separators onto take-up surfaces of the respective plurality of separator rolls.

The method in accordance with an aspect of the present invention for producing a separator roll includes the steps of: (a) slitting an original sheet of a battery separator in a lengthwise direction so as to divide the original sheet into a plurality of separators; (b) winding one of the plurality of separators on a core; (c) pressing, by a touch roller, the one of the plurality of separators onto a take-up surface of a separator roll which has been formed on the core, a position of the touch roller being changed in accordance with a change in outer diameter of the separator roll; and (d) conveying, by a take-up assisting roller, the one of the plurality of separators immediately before the touch roller, a position of the take-up assisting roller being changed in accordance with positional change of the touch roller.

The method in accordance with an aspect of the present invention for producing a separator roll includes the steps of: (a) slitting an original sheet of a battery separator in a lengthwise direction so as to divide the original sheet into a plurality of separators; (b) winding one of the plurality of separators on a core; (c) pressing, by a touch roller, the one of the plurality of separators onto a take-up surface of a separator roll which has been formed on the core, a position of the touch roller being changed in accordance with a change in outer diameter of the separator roll; and (d) conveying, by a take-up assisting roller, the one of the plurality of separators immediately before the touch roller, the take-up assisting roller being attached to a roller attaching section which is provided so that a distance between the touch roller and the take-up assisting roller is selectable from a plurality of distances.

The method in accordance with an aspect of the present invention for producing a separator roll includes the steps of: (a) slitting an original sheet of a battery separator in a lengthwise direction so as to divide the original sheet into a plurality of separators; (b) winding the plurality of separators on respective of a plurality of cores which are held on one (1) rotation shaft; and (c) pressing, by a plurality of touch rollers, the plurality of separators onto respective take-up surfaces of a plurality of separator rolls which have been formed on the respective plurality of cores, the plurality of touch rollers being provided for the one (1) rotation shaft and positions of the plurality of touch rollers being separately changed in accordance with changes in outer diameter of the plurality of separator rolls.

### Advantageous Effects of Invention

According to an aspect of the present invention, it is possible to inhibit a wrinkle or misaligned winding caused in a separator.

### BRIEF DESCRIPTION OF DRAWINGS

FIG. 1 is a schematic view illustrating a cross sectional configuration of a lithium-ion secondary battery.

FIG. 2 is a schematic view illustrating details of a configuration of the lithium-ion secondary battery illustrated in FIG. 1.

FIG. 3 is a schematic view illustrating another configuration of the lithium-ion secondary battery illustrated in FIG. 1.

FIG. 4 is a schematic view illustrating a configuration of a slitting apparatus for slitting the separator.

FIG. 5 is a side view and a front view illustrating a configuration of a cutting device of the slitting apparatus illustrated in FIG. 4.

FIG. 6 is an enlarged view of the range C in FIG. 4 and illustrates a slitting apparatus in accordance with an embodiment of the present invention.

FIG. 7 is an enlarged view illustrating a part relating to a first touch roller and a first take-up assisting roller in the slitting apparatus.

FIG. 8 is an enlarged view illustrating a part relating to a first touch roller and a first take-up assisting roller in the slitting apparatus.

FIG. 9 is a plan view which is viewed from above and illustrates a part relating to first touch rollers and first take-up assisting rollers in the slitting apparatus.

FIG. 10 is a view illustrating an arrangement of a take-up assisting roller in accordance with another embodiment of the present invention.

FIG. 11 is an enlarged view illustrating a part of a slitting apparatus in accordance with still another embodiment of the present invention.

FIG. 12 is a view illustrating a modification example of a roller attaching section in an arm.

FIG. 13 is a view illustrating a modification example of a take-up assisting roller in a case where an arm has a roller attaching section that is an elongated hole.

### DESCRIPTION OF EMBODIMENTS

[Basic Configuration]

The following discusses in order a lithium-ion secondary battery, a separator, a heat-resistant separator, a method for producing the heat-resistant separator, a slitting apparatus, and a cutting device.

(Lithium-Ion Secondary Battery)

A nonaqueous electrolyte secondary battery, typically, a lithium-ion secondary battery has a high energy density, and therefore, currently widely used not only as batteries for use in devices such as personal computers, mobile phones, and mobile information terminals, and for use in moving bodies such as automobiles and airplanes, but also as stationary batteries contributing to stable power supply.

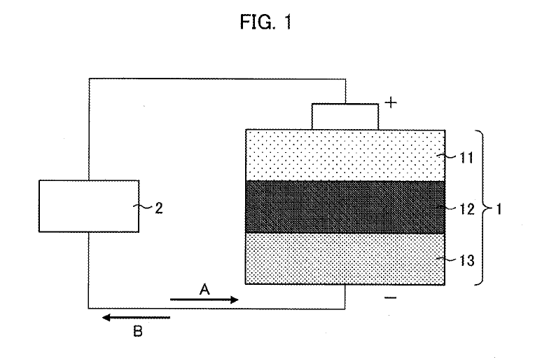

FIG. 1 is a schematic view illustrating a cross sectional configuration of a lithium-ion secondary battery 1.

As illustrated in FIG. 1, the lithium-ion secondary battery 1 includes a cathode 11, a separator 12, and an anode 13. Between the cathode 11 and the anode 13, an external device 2 is connected outside the lithium-ion secondary battery 1. Then, while the lithium-ion secondary battery 1 is being charged, electrons move in a direction A. On the other hand, while the lithium-ion secondary battery 1 is being discharged, electrons move in a direction B.

(Separator)

The separator 12 is provided so as to be sandwiched between the cathode 11 which is a positive electrode of the lithium-ion secondary battery 1 and the anode 13 which is a negative electrode of the lithium-ion secondary battery 1. The separator 12 is a porous film which separates the cathode 11 and the anode 13, allowing lithium ions to move between the cathode 11 and the anode 13. The separator 12 contains, for example, polyolefin such as polyethylene or polypropylene as a material.

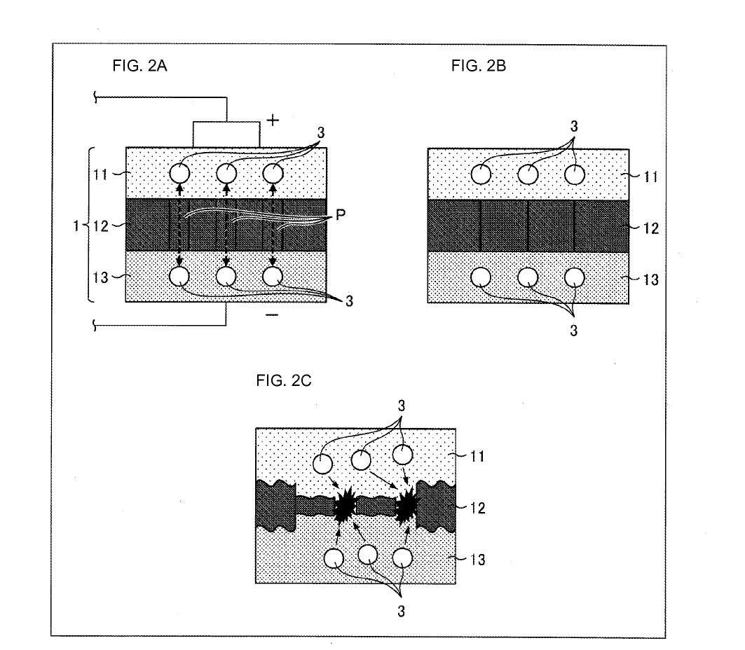

FIG. 2 is a schematic view illustrating details of the configuration of the lithium-ion secondary battery 1 illustrated in FIG. 1. (a) of FIG. 2 illustrates a normal configuration. (b) of FIG. 2 illustrates a state in which a temperature of the lithium-ion secondary battery 1 has risen. (c) of FIG. 2 illustrates a state in which a temperature of the lithium-ion secondary battery 1 has sharply risen.

As illustrated in (a) of FIG. 2, the separator 12 is provided with many pores P. Normally, lithium ions 3 in the lithium-ion secondary battery 1 can move back and forth through the pores P.

However, there are, for example, cases in which the temperature of the lithium-ion secondary battery 1 rises due to excessive charging of the lithium-ion secondary battery 1, a high current caused by short-circuiting of the external device, or the like. In such cases, the separator 12 melts or softens and the pores P are blocked as illustrated in (b) of FIG. 2. As a result, the separator 12 shrinks. This stops the movement of the lithium ions 3, and consequently stops the above temperature rise.

However, in a case where a temperature of the lithium-ion secondary battery 1 sharply rises, the separator 12 suddenly shrinks. In this case, as illustrated in (c) of FIG. 2, the separator 12 may be destroyed. Then, the lithium ions 3 leak out from the separator 12 which has been destroyed. As a result, the lithium ions 3 do not stop moving. Consequently, the temperature continues rising.

(Heat-Resistant Separator)

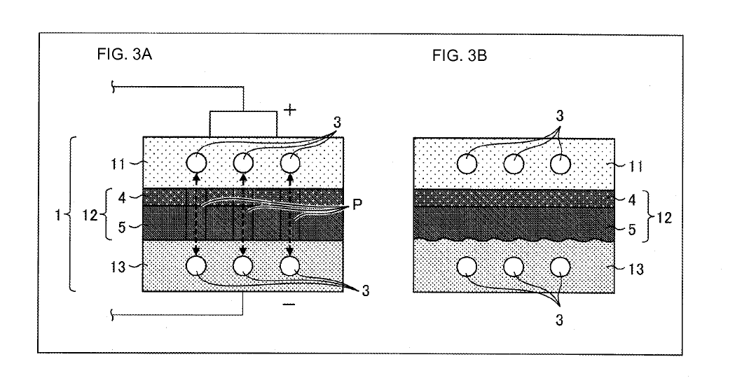

FIG. 3 is a schematic view illustrating another configuration of the lithium-ion secondary battery 1 illustrated in FIG. 1. (a) of FIG. 3 illustrates a normal configuration, and (b) of FIG. 3 illustrates a state in which a temperature of the lithium-ion secondary battery 1 has sharply risen.

As illustrated in (a) of FIG. 3, the separator 12 can be a heat-resistant separator that includes a porous film 5 and a heat-resistant layer 4. The heat-resistant layer 4 is laminated on a surface of the porous film 5 which surface is on a cathode 11 side. Note that the heat-resistant layer 4 can alternatively be laminated on a surface of the porous film 5 which surface is on an anode 13 side, or both surfaces of the porous film 5. Further, the heat-resistant layer 4 is provided with pores which are similar to the pores P. Normally, the lithium ions 3 move through the pores P and the pores of the heat-resistant layer 4. The heat-resistant layer 4 contains, for example, wholly aromatic polyamide (aramid resin) as a material.

As illustrated in (b) of FIG. 3, even in a case where the temperature of the lithium-ion secondary battery 1 sharply rises and as a result, the porous film 5 melts or softens, the shape of the porous film 5 is maintained because the heat-resistant layer 4 supports the porous film 5. Therefore, such a sharp temperature rise results in only melting or softening of the porous film 5 and consequent blocking of the pores P. This stops movement of the lithium ions 3 and consequently stops the above-described excessive discharging or excessive charging. In this way, the separator 12 can be prevented from being destroyed.

(Production Steps of the Heat-Resistant Separator)

How to produce the heat-resistant separator of the lithium-ion secondary battery 1 is not specifically limited. The heat-resistant separator can be produced by a well-known method. The following discussion assumes a case where the porous film 5 contains polyethylene as a main material. However, even in a case where the porous film 5 contains another material, the similar steps can still be applied to production of the separator 12.

For example, it is possible to employ a method including the steps of first forming a film by adding a plasticizer to a thermoplastic resin, and then removing the plasticizer with an appropriate solvent. For example, in a case where the porous film 5 is made of a polyethylene resin containing ultrahigh molecular weight polyethylene, it is possible to produce the separator 12 by the following method.

This method includes (1) a kneading step of obtaining a polyethylene resin composition by kneading a ultrahigh molecular weight polyethylene and an inorganic filler such as calcium carbonate, (2) a rolling step of forming a film with the polyethylene resin composition, (3) a removal step of removing the inorganic filler from the film obtained in the step (2), and (4) a stretching step of obtaining the porous film 5 by stretching the film obtained in the step (3).

In the removal step, many fine pores are provided in the film. The fine pores of the film stretched in the stretching step become the above-described pores P. The porous film 5 formed as a result is a polyethylene microporous film having a prescribed thickness and a prescribed air permeability.

Note that in the kneading step, 100 parts by weight of the ultrahigh molecular weight polyethylene, 5 parts by weight to 200 parts by weight of a low-molecular weight polyolefin having a weight-average molecular weight of 10000 or less, and 100 parts by weight to 400 parts by weight of the inorganic filler can be kneaded.

Thereafter, in a coating step, the heat-resistant layer 4 is formed on a surface of the porous film 5. For example, on the porous film 5, an aramid/NMP (N-methylpyrrolidone) solution (coating solution) is applied, and thereby, the heat-resistant layer 4 that is an aramid heat-resistant layer is formed. The heat-resistant layer 4 can be provided on only one surface or both surfaces of the porous film 5. Alternatively, the heat-resistant layer 4 can be formed by using a mixed solution containing a filler such as alumina/carboxymethyl cellulose for coating.

A method for coating the porous film 5 with a coating solution is not specifically limited as long as uniform wet coating can be performed by the method. The method can be a conventionally well-known method such as a capillary coating method, a spin coating method, a slit die coating method, a spray coating method, a dip coating method, a roll coating method, a screen printing method, a flexo printing method, a bar coater method, a gravure coater method, or a die coater method. The heat-resistant layer 4 has a thickness which can be controlled by adjusting a thickness of a coating wet film and a solid-content concentration in the coating solution.

It is possible to use a resin film, a metal belt, a drum or the like as a support with which the porous film 5 is fixed or transferred in coating.

As described above, it is possible to produce the separator 12 (heat-resistant separator) in which the heat-resistant layer 4 is laminated on the porous film 5. Thus produced separator is wound on a cylindrical core. Note that a subject to be produced by the above production method is not limited to the heat-resistant separator. The above production method does not necessarily include the coating step. In a case where the method includes no coating step, the subject to be produced is a separator that does not have a heat-resistant layer.

(Slitting Apparatus)

The heat-resistant separator or the separator having no heat-resistant layer (hereinafter, referred to as “separator”) preferably has a width (hereinafter, referred to as “product width”) suitable for application products such as the lithium-ion secondary battery 1. However, for improving productivity, the separator is produced so as to have a width that is equal to or larger than a product width. Then, after having been once produced so as to have a width equal to or larger than the product width, the separator is slit into a separator(s) having the product width.

Note that the “separator width” means a dimension of the separator in a direction substantially perpendicular to a lengthwise direction and a thickness direction of the separator. In the description below, a wide separator having not yet been slit is referred to as an “original sheet” while particularly a separator having been slit is referred to as a “slit separator”. Moreover, “slit” means to cut off a separator in a lengthwise direction (i.e., a direction in which a film flows in production, MD: machine direction), and “cut” means to cut the separator in a transverse direction (TD). The transverse direction (TD) means a direction that is substantially perpendicular to the lengthwise direction (MD) and the thickness direction of the separator.

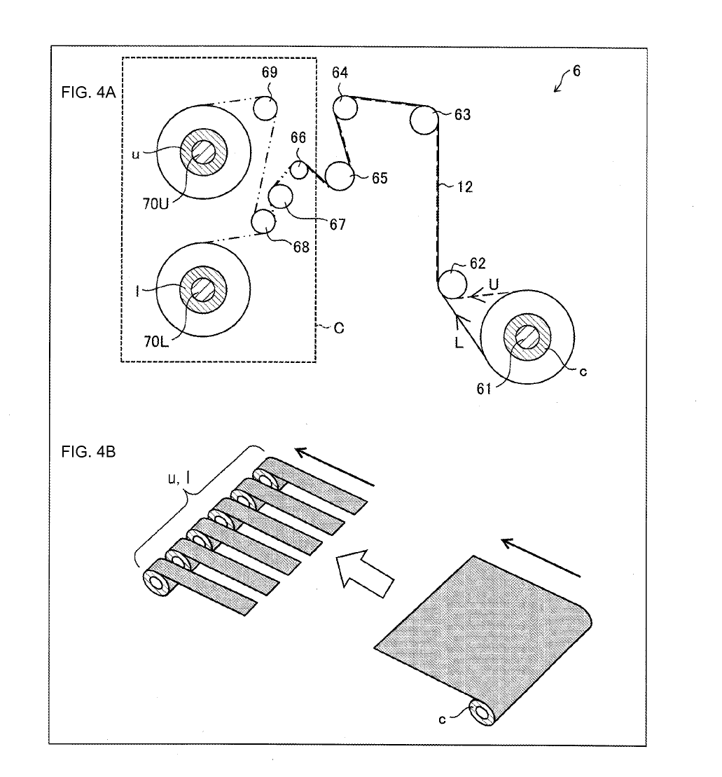

FIG. 4 is a schematic view illustrating a configuration of a slitting apparatus 6 for slitting the separator. (a) of FIG. 4 illustrates an entire configuration, and (b) of FIG. 4 illustrates an arrangement before and after slitting the original sheet.

As illustrated in (a) of FIG. 4, the slitting apparatus 6 includes a rotatably-supported cylindrical wind-off roller 61, rollers 62 to 69, and take-up rollers 70U and 70L. The slitting apparatus 6 is further provided with the cutting device 7 described later.

(Before Slitting)

In the slitting apparatus 6, a cylindrical core c on which the original sheet is wrapped is fit on the wind-off roller 61. As illustrated in (b) of FIG. 4, the original sheet is wound off from the core c to a route U or L. Thus unwound original sheet is conveyed to the roller 68 via the rollers 63 through 67. In the step of conveying the unwound original sheet, the original sheet is slit into slit separators.

(After Slitting)

As illustrated in (b) of FIG. 4, some of the slit separators are wound on respective cylindrical cores u (bobbin) fit on the take-up roller 70U. Meanwhile, the others of the slit separators are wound on respective cores 1 (bobbin) fit on the take-up roller 70L. Note that each of the slit separators wound into a roll form is referred to as a “separator roll”.

(Cutting Device)

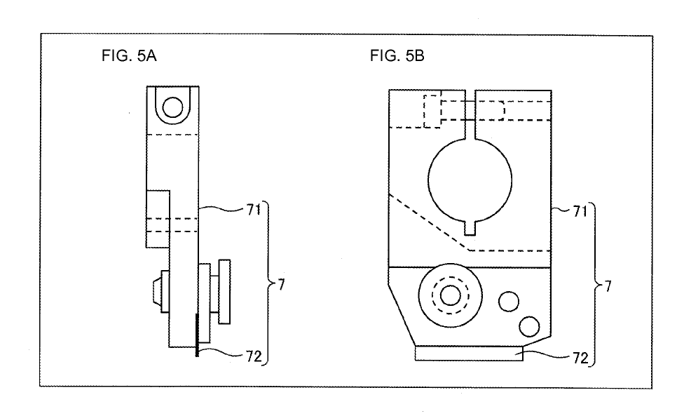

FIG. 5 is a view illustrating a configuration of the cutting device 7 of the slitting apparatus 6 as illustrated in (a) of FIG. 4. (a) of FIG. 5 is a side view of the cutting device 7, and (b) of FIG. 5 is a front view of the cutting device 7.

As illustrated in (a) and (b) of FIG. 5, the cutting device 7 includes a holder 71 and a blade 72. The holder 71 is fixed to a housing or the like provided in the slitting apparatus 6. The holder 71 holds the blade 72 in a manner such that the blade 72 and the original sheet of the separator being conveyed have a fixed positional relation. The blade 72 has a finely sharpened edge and slits the original sheet of the separator by using this edge.

### Embodiment 1

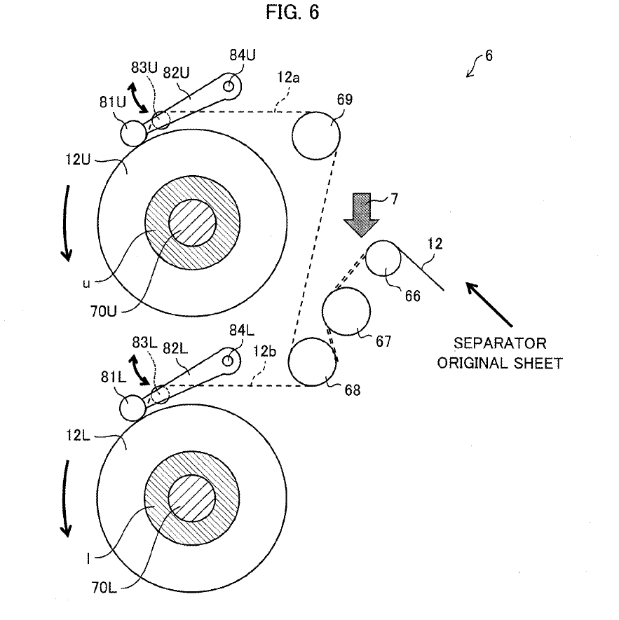

FIG. 6 is an enlarged view illustrating the range C in the slitting apparatus illustrated in FIG. 4. Arrows in FIG. 6 indicate flows of separators and movements of arms. The slitting apparatus 6 includes rollers 66 through 69, a first touch roller 81U, a second touch roller 81L, a first arm 82U, a second arm 82L, a first take-up assisting roller 83U, a second take-up assisting roller 83L, a first take-up roller 70U, a second take-up roller 70L, and a plurality of cutting devices 7. The rollers 66 through 69 are provided so as to convey separators. The first touch roller 81U and the second touch roller 81L are rotatably provided (fixed) at respective one ends of the first arm 82U and the second arm 82L. The first arm 82U and the second arm 82L can rotationally swing around rotation shafts 84U and 84L (shaft), respectively, which are provided at the other ends thereof. The first take-up assisting roller 83U is provided between the first touch roller 81U and the rotation shaft 84U of the first arm 82U and is rotatably fixed to the first arm 82U. The second take-up assisting roller 83L is provided between the second touch roller 81L and the rotation shaft 84L of the second arm 82L and is rotatably fixed to the second arm 82L.

An original sheet of a separator 12 which is long and has been conveyed is slit into a plurality of slit separators by the plurality of cutting devices 7 (slitting section) on, for example, an upstream side or a downstream side of the roller 66 (slitting step). Hereinafter, among the plurality of slit separators arranged side by side, each of odd-numbered slit separators is referred to as “first separator 12a”, and each of even-numbered slit separators is referred to as “second separator 12b”. The first separator 12a and the second separator 12b are conveyed to the roller 68 via the roller 67.

A holding angle of the first separator 12a on the roller 68 is different from a holding angle of the second separator 12b on the roller 68. Here, the holding angle means an angle of an arc, on which the separator makes contact with the roller, with respect to an axis of the roller. That is, directions in which a separator is conveyed before and after a roller vary by a holding angle of the roller. The roller 68 (i) changes a conveying direction of the first separator 12a toward a first take-up roller 70U side and (ii) changes a conveying direction of the second separator 12b toward a second take-up roller 70L side (direction changing step). The first separator 12a and the second separator 12b are to be conveyed in different directions by the roller 68.

The first take-up roller 70U (take-up section) is provided with one or more cores u in a removable manner, depending on the number of the first separator(s) 12a. Similarly, the second take-up roller 70L (take-up section) is provided with one or more cores 1 in a removable manner, depending on the number of the second separator(s) 12b.

The first separator 12a which has been conveyed toward the first take-up roller 70U side by the roller 68 is conveyed by the roller 69. The first separator 12a is conveyed from the roller 69 via the first take-up assisting roller 83U and the first touch roller 81U (conveying step), and is then introduced to a take-up surface. The first separator 12a is wound on a core u, so that a first separator roll 12U is formed. The first take-up roller 70U rotates together with the core u so as to take up the first separator 12a (taking-up step). The core can be removed from the take-up roller together with the separator roll that has been wound on the core.

The second separator 12b which has been conveyed by the roller 68 to the second take-up roller 70L side is conveyed via the second take-up assisting roller 83L and the second touch roller 81L (conveying step), and is then introduced to a take-up surface. The second separator 12b is wound on a core 1, so that a second separator roll 12L is formed. The second take-up roller 70L rotates together with the core 1 so as to take up the second separator 12b (taking-up step).

Note that the first touch roller 81U and the second touch roller 81L press respective of the first separator 12a and the second separator 12b toward take-up surfaces (front surfaces) of respective of the first separator roll 12U and the second separator roll 12L which are being wound (pressing step). Here, the first touch roller 81U and the second touch roller 81L press respective of the first separator 12a and the second separator 12b by their own weights. By thus pressing the first separator 12a and the second separator 12b by respective of the first touch roller 81U and the second touch roller 81L, it is possible to inhibit wrinkles and the like caused in the first separator 12a and the second separator 12b which are wound. Note that positions of the first touch roller 81U and the second touch roller 81L vary (are displaced) depending on changes in outer diameter of the first separator roll 12U and the second separator roll 12L so as to make contact with the respective take-up surfaces of the first separator roll 12U and the second separator roll 12L.

The first take-up roller 70U and the second take-up roller 70L are provided in respective different positions so that the first separator roll 12U and the second separator roll 12L which have been wound on the respective cores u and l do not make contact with each other. The first separator 12a and the second separator 12b are formed by slitting a single original sheet of separator, and therefore there is substantially no gap between the first separator roll 12U and the second separator roll 12L which are adjacent to each other in the transverse direction (TD). In a case where lateral surfaces (which are perpendicular to the shaft) of the first separator roll 12U and the second separator roll 12L make contact with each other, a scratch or fluff may occur on the lateral surfaces. In view of this, the first take-up roller 70U and the second take-up roller 70L are arranged far enough to a degree that the lateral surfaces of respective of the first separator roll 12U and the second separator roll 12L do not make contact with each other. In this case, the first take-up roller 70U and the second take-up roller 70L are arranged to have a positional relation of above and below in the slitting apparatus 6. By thus arranging the first take-up roller 70U and the second take-up roller 70L in the positional relation of above and below, it is possible to reduce a size of the slitting apparatus 6 in a horizontal direction. The first take-up roller 70U and the second take-up roller 70L do not need to be aligned in a vertical direction, and the “positional relation of above and below” indicates a positional relation in which the first take-up roller 70U and the second take-up roller 70L are not horizontally aligned.

The first take-up roller 70U and the second take-up roller 70L are arranged apart from each other by a predetermined distance. By this restriction of arrangement, a roller-to-roller distance from the roller 69 to the first touch roller 81U or a roller-to-roller distance from the roller 68 to the second touch roller 81L becomes relatively long. Here, the roller-to-roller distance means a distance (i) between two adjacent rollers on a conveying route of a separator and (ii) from a position at which the separator is off from an upstream one of the two rollers on the conveying route to a position at which the separator makes contact with a downstream one of the two rollers. In a case where a roller-to-roller distance from a roller immediately before a touch roller to the touch roller is long, the separator is more likely to be deformed or to meander, and consequently the separator which is wound tends to have a wrinkle or misaligned winding. Here, the wrinkle indicates, for example, a wrinkle which occurs in the take-up surface of the separator roll (i.e., in a curved surface with which the touch roller makes contact). The misaligned winding indicates that a part of a separator is misaligned in an axis direction of a columnar separator roll. In a case where misaligned winding has been caused, lateral surfaces (which are perpendicular to the shaft) of the separator roll become uneven. Note that a separator (e.g., a heat-resistant separator) which is formed by coating a porous film with a layer such as a heat-resistant layer is more likely to be curled in the transverse direction. Under the circumstances, in order to inhibit a wrinkle caused by the curl, it is necessary to shorten a roller-to-roller distance to the touch roller. Moreover, in a case where the thickness of the separator is thin, a wrinkle easily occurs.

(Change in Position of Touch Roller)

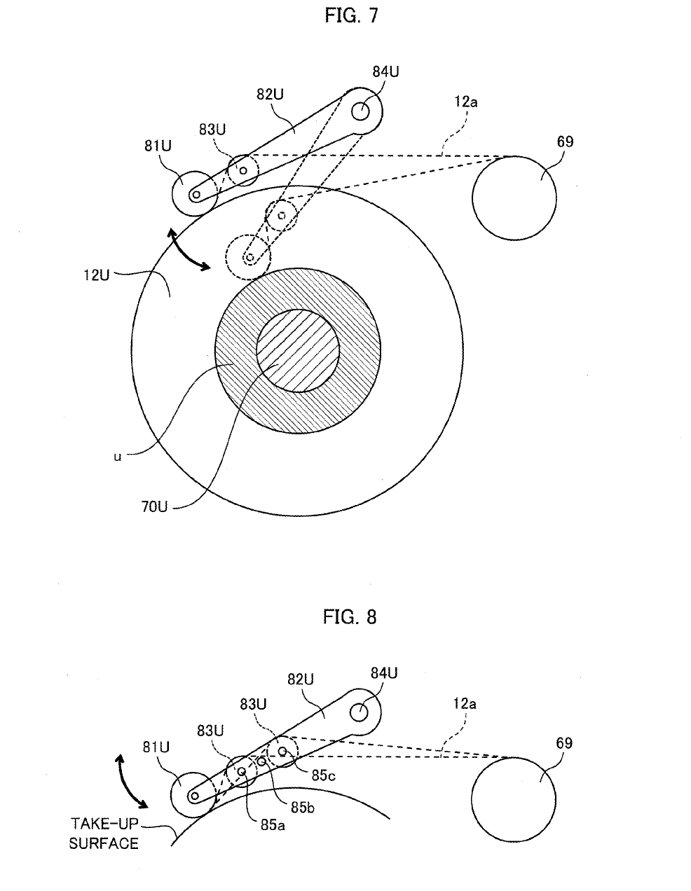

FIG. 7 is an enlarged view illustrating a part relating to the first touch roller 81U and the first take-up assisting roller 83U in the slitting apparatus 6. In FIG. 7, dotted lines indicate positions of the first touch roller 81U, the first take-up assisting roller 83U, and the first arm 82U at a beginning of winding the first separator 12a on the core u. In the present embodiment, the first take-up assisting roller 83U is provided, on the conveying route, between the roller 69 and the first touch roller 81U so as to shorten the roller-to-roller distance to the first touch roller 81U. The first take-up assisting roller 83U does not make contact with the first separator roll 12U. The first take-up assisting roller 83U is fixed to the first arm 82U, and therefore a position of the first take-up assisting roller 83U is changed in accordance with positional change of the first touch roller 81U that makes contact with the first separator roll 12U. That is, a distance between the first take-up assisting roller 83U and the first touch roller 81U is retained constant, regardless of an outer diameter of the first separator roll 12U. In this case, the first arm 82U is configured to rotationally swing around its rotation axis. Note, however, that the first arm 82U can be configured to move (be displaced) in parallel in accordance with positional change of the first touch roller 81U.

The first separator 12a passes through on the first take-up assisting roller 83U on an upper side (which is an opposite side of the first separator roll 12U), then passes through between the first take-up assisting roller 83U and the first touch roller 81U, then passes through between the first touch roller 81U and the first separator roll 12U, and is then wound. That is, with respect to a plane including the rotation shaft of the first touch roller 81U and the rotation shaft of the first take-up assisting roller 83U, the first separator 12a passes through on the first take-up assisting roller 83U on one side, and passes through on the first touch roller 81U on the other side. The first separator 12a which has been conveyed from the first take-up assisting roller 83U makes contact with the first touch roller 81U before making contact with the take-up surface. The first separator 12a which is being conveyed on the first touch roller 81U is pressed onto the take-up surface in a state in which a wrinkle is stretched (i.e., in a state of no wrinkle).

The second take-up assisting roller 83L has a configuration similar to that of the first take-up assisting roller 83U. Note that the rollers 68 and 69, the first take-up roller 70U, and the second take-up roller 70L are separated from the first touch roller 81U and the second touch roller 81L. That is, during production of a separator roll, positions of the rollers 68 and 69, the first take-up roller 70U, and the second take-up roller 70L are fixed regardless of outer diameters of respective of the first separator roll 12U and the second separator roll 12L.

By providing the first take-up assisting roller 83U, whose position is changed in accordance with positional change of the first touch roller 81U, immediately before the first touch roller 81U, it is possible to shorten the roller-to-roller distance between the first touch roller 81U and a roller immediately before the first touch roller 81U. This makes it possible to inhibit a wrinkle or misaligned winding caused in the first separator roll 12U.

Note that the first touch roller 81U can be configured to press the first separator 12a onto the take-up surface from a lateral side or a lower side of the first separator roll 12U. In this case, for example, the slitting apparatus 6 can be provided with a mechanism such as a spring or an air cylinder for applying force to the first arm 82U. The same applies to the second touch roller 81L.

(Attaching Position of Take-Up Assisting Roller)

FIG. 8 is an enlarged view illustrating a part relating to the first touch roller 81U and the first take-up assisting roller 83U in the slitting apparatus 6. FIG. 8 illustrates a plurality of positions for attaching the first take-up assisting roller 83U. The first arm 82U has roller attaching sections 85a through 85c for attaching the first take-up assisting roller 83U. Each of the roller attaching sections 85a through 85c can be, for example, a bearing for rotatably supporting the first take-up assisting roller 83U or a hole for fixing the bearing. A user sets the first take-up assisting roller 83U in one roller attaching section which has been selected in advance from the roller attaching sections 85a through 85c. From this, the user can select one of a plurality of distances between the first touch roller 81U and the first take-up assisting roller 83U. FIG. 8 illustrates both (i) a state in which the first take-up assisting roller 83U is attached to the roller attaching section 85a and (ii) a state in which the first take-up assisting roller 83U is attached to the roller attaching section 85c.

By changing the attaching position of the first take-up assisting roller 83U, it is possible to change a roller-to-roller distance between the first touch roller 81U and the first take-up assisting roller 83U and a position at which the first separator 12a makes contact with the first touch roller 81U. A wound state of the separator roll (i.e., a state of a wrinkle or misaligned winding) can be changed by a characteristic (physical property) of the separator. In the present embodiment, it is possible to adjust the wound state of the first separator roll 12U by changing the distance between the first touch roller 81U and the first take-up assisting roller 83U. Note that the second arm 82L can have a configuration similar to that of the first arm 82U.

(Arrangement of a Plurality of Touch Rollers)

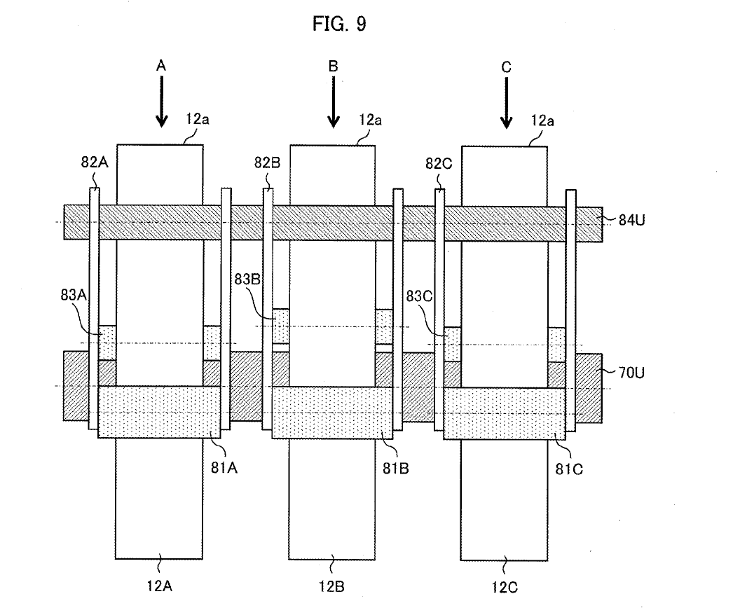

FIG. 9 is a plan view which is viewed from above and illustrates a part relating to the first touch roller and the first take-up assisting roller in the slitting apparatus 6. In FIG. 9, dashed dotted lines represent axes. Note that the second touch roller, the second take-up assisting roller, and the like are similarly configured, and therefore only the first touch roller and the like are explained here. A plurality of first separators 12a are wound as first separator rolls 12A through 12C, respectively. In FIG. 9, arrows represent flows of the first separators 12a in respective three rows (A through C). On one (1) rotation shaft 84U, first arms 82A through 82C are provided. The first arms 82A through 82C can separately and independently rotate around the rotation shaft 84U. Each of the first arms 82A through 82C includes two arm parts which are provided on both sides of corresponding one of the first touch rollers 81A through 81C. The first touch rollers 81A through 81C are rotatably fixed to the respective first arms 82A through 82C, and the first take-up assisting rollers 83A through 83C are also rotatably fixed to the respective first arms 82A through 82C.

The first take-up roller 70U is one (1) rotation shaft that holds a plurality of cores. The first take-up roller 70U is rotated by a driving motor (not illustrated) or the like. The one (1) first take-up roller 70U and the plurality of cores fixed to the first take-up roller 70U rotate as a unit. On the plurality of cores, the first separator rolls 12A through 12C are formed, respectively. The first touch rollers 81A through 81C are provided for the respective first separator rolls 12A through 12C.

As such, the first touch rollers 81A through 81C are provided for the one (1) first take-up roller 70U. The first arms 82A through 82C can separately rotate, and therefore positions of the first touch rollers 81A through 81C are separately changed in accordance with changes in outer diameter of the respective first separator rolls 12A through 12C. In a case where thickness distribution of the original sheet of separator is not uniform in the transverse direction (TD), the first separator rolls 12A through 12C may have respective different outer diameters. Even in such a case, in the present embodiment, the positions of the first touch rollers 81A through 81C are separately changed in accordance with changes in outer diameter of the respective first separator rolls 12A through 12C. It is therefore possible to prevent a gap (space) from occurring between the first touch roller and the first separator roll. From this, it is possible to presses the plurality of first separators onto respective take-up surfaces by the respective first touch rollers.

As illustrated in FIG. 9, attaching positions of the respective first take-up assisting rollers 83A through 83C can be different from each other for the respective first arms. In a case where thickness distribution of the original sheet of separator is not uniform, a first separator 12a which passes through on the first take-up assisting roller 83A can have a thickness different from that of a first separator 12a which passes through on the first take-up assisting roller 83B. Moreover, besides the thickness, other physical property can be different. The user can adjust the wound states of the first separator rolls 12A through 12C by changing positions of the respective first take-up assisting rollers 83A through 83C in accordance with the respective states of the corresponding rows A through C.

According to the present embodiment, the effect of inhibiting a wrinkle or misaligned winding is particularly suitable for a separator that is used in a battery. A separator (in particular, a separator coated with a layer) tends to have uneven film thickness distribution, and therefore a wrinkle or misaligned winding is more likely to occur when taking up the separator. Meanwhile, in a case where a wrinkle or misaligned winding is caused in a separator roll, the separator easily meanders when the separator is wound off in a battery production process. In a case where the separator meanders, defect is caused in lamination of a positive electrode film and a negative electrode film between which the separator is provided. As such, the separator roll is highly demanded to have less wrinkles and less misaligned winding, and it is therefore necessary to provide the take-up assisting roller. The present embodiment is applicable (i) to a single-layer separator that does not have a heat-resistant layer and (ii) also to a heat-resistant separator having a heat-resistant layer.

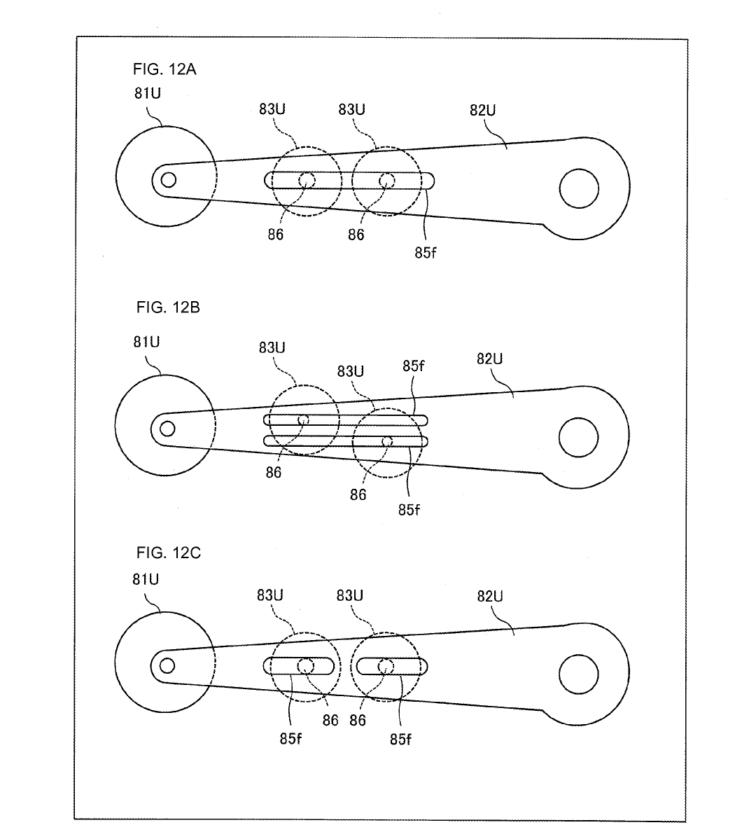

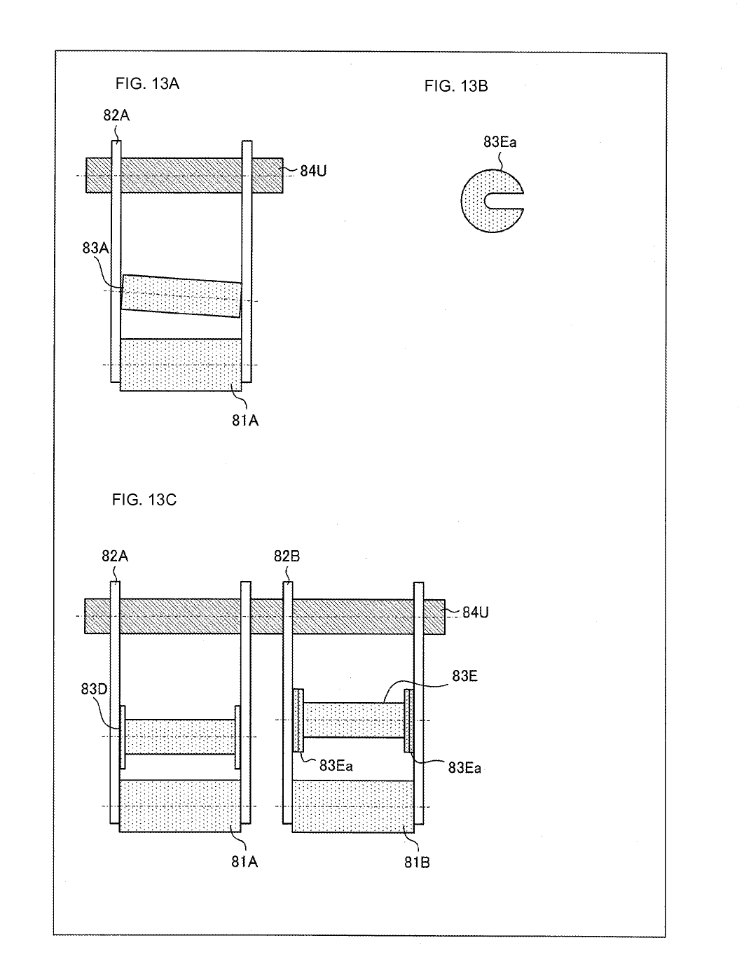

FIG. 12 is a view illustrating a modification example of a roller attaching section in an arm. Here, the first arm 82U is described as an example, and a similar description applies to the second arm 82L. FIG. 12 illustrates both (i) a state in which the first take-up assisting roller 83U is provided at a certain position and (ii) a state in which the first take-up assisting roller 83U is provided at another position.

In an example illustrated in (a) of FIG. 12, the first arm 82U has one (1) roller attaching section 85f which is an elongated hole, instead of the plurality of roller attaching sections. By fixing a shaft 86 of the first take-up assisting roller 83U within a range of the elongated hole of the roller attaching section 85f, a position of the first take-up assisting roller 83U is determined. That is, the user can select one of a plurality of distances between the first touch roller 81U and the first take-up assisting roller 83U. Note that the first take-up assisting roller 83U is rotatably supported by the shaft 86. By thus using the elongated hole, it is possible to finely adjust a position of the first take-up assisting roller 83U.

In an example illustrated in (b) of FIG. 12, the first arm 82U has a plurality of roller attaching sections 85f each of which is an elongated hole. In this case, two roller attaching sections 85f are aligned in a direction perpendicular to a long-axis direction of the elongated hole. The first take-up assisting roller 83U is fixed at an arbitrary position in any of the plurality of roller attaching sections 85f.

In an example illustrated in (c) of FIG. 12, the first arm 82U has a plurality of roller attaching sections 85f each of which is an elongated hole. In this case, two roller attaching sections 85f are aligned in a long-axis direction of the elongated hole. The first take-up assisting roller 83U is fixed at an arbitrary position in any of the plurality of roller attaching sections 85f.

FIG. 13 is a view illustrating a modification example of a take-up assisting roller in a case where an arm has a roller attaching section that is an elongated hole. Each of (a) of FIG. 13 and (c) of FIG. 13 is a plan view in which a part relating to the first arm, the first touch roller, and the first take-up assisting roller is viewed from above. In a case where the roller attaching section is an elongated hole, as illustrated in (a) of FIG. 13, the first take-up assisting roller 83A may be fixed to the first arm 82A in a state in which an axis of the first take-up assisting roller 83A is inclined with respect to an axis of the first touch roller 81A or the like.

In order to prevent the axis of the first take-up assisting roller from being inclined, a first take-up assisting roller 83D can have flanges which are provided on both end parts of the first take-up assisting roller 83D and have a diameter larger than that of a roller part for guiding a separator (see (c) of FIG. 13). The flanges are arranged along the first arm 82A, and it is therefore possible to prevent inclination of the first take-up assisting roller 83D. Note that the flanges can rotate together with the first take-up assisting roller 83D or can be fixed together with a shaft of the first take-up assisting roller 83D.

A spacer 83Ea illustrated in (b) of FIG. 13 can be provided (inserted) at an end part of the first take-up assisting roller 83E. The spacer 83Ea has a shape in which a circular plate is partially notched (at a position corresponding to the shaft). By providing one or more spacers 83Ea between the first take-up assisting roller 83E and the first arm 82B, it is possible to prevent the axis of the first take-up assisting roller 83E from being inclined. A diameter of the spacer 83Ea can be larger or smaller than a diameter of the first take-up assisting roller. By filling a gap between the first take-up assisting roller 83E and the first arm 82B with the spacer 83Ea, inclination of axis is prevented. Note that the spacer 83Ea can be fixed together with the shaft of the first take-up assisting roller 83E.

### Embodiment 2

The following description will discuss another embodiment of the present invention. Note that, for convenience of explanation, identical reference numerals are given to members which have respective functions identical with those described in the above embodiments, and descriptions of the respective members are omitted. According to the present embodiment, a take-up assisting roller is provided independently from an arm to which a touch roller is fixed. The same can apply to a second take-up assisting roller and the like, and therefore only the first take-up assisting roller and the like are described here.

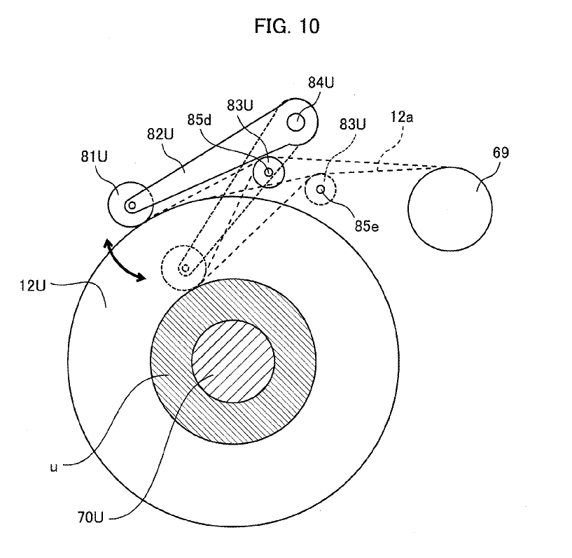

FIG. 10 is a view illustrating an arrangement of a take-up assisting roller in accordance with the present embodiment. The slitting apparatus of the present embodiment has roller attaching sections 85d and 85e which are not provided in the first arm 82U. The roller attaching sections 85d and 85e are provided in, for example, a part that is fixed to a housing or a frame of the slitting apparatus. The user can select one of the roller attaching sections 85d and 85e as a position at which the first take-up assisting roller 83U is attached. The roller attaching sections 85d and 85e are fixed to the slitting apparatus (or the first take-up roller 70U), and therefore the position of the first take-up assisting roller 83U during production of a separator roll is fixed, regardless of an outer diameter of the first separator roll 12U. In such a configuration, it is possible to adjust a roller-to-roller distance to the first touch roller 81U.

In FIG. 10, positions of the first touch roller 81U and the first arm 82U at a beginning of winding the first separator 12a on the core u are indicated by dotted lines. Moreover, in FIG. 10, a position of the first take-up assisting roller 83U in a case where the first take-up assisting roller 83U is attached to the roller attaching section 85e is indicated by dotted lines. A conveying route of the first separator 12a varies depending on the position of the first take-up assisting roller 83U and the outer diameter of the first separator roll 12U, and FIG. 10 illustrates those variations. Here, in a case where the first take-up assisting roller 83U is attached to the roller attaching section 85e and the outer diameter of the first separator roll 12U is increased to a certain degree, the first separator 12a is to make contact with the first separator roll 12U before making contact with the first touch roller 81U. It is possible to employ a configuration in which an upper end of the first take-up assisting roller 83U (at which the first separator 12a passes through) is located upper than a lower end of the first touch roller 81U (at which the first separator 12a passes through) regardless of the outer diameter of the first separator roll 12U. Of course, as in FIG. 9, it is possible to provide a plurality of first touch rollers 81U and a plurality of first take-up assisting rollers 83U for one (1) first take-up roller 70U.

### Embodiment 3

The following description will discuss still another embodiment of the present invention. Note that, for convenience of explanation, identical reference numerals are given to members which have respective functions identical with those described in the above embodiments, and descriptions of the respective members are omitted.

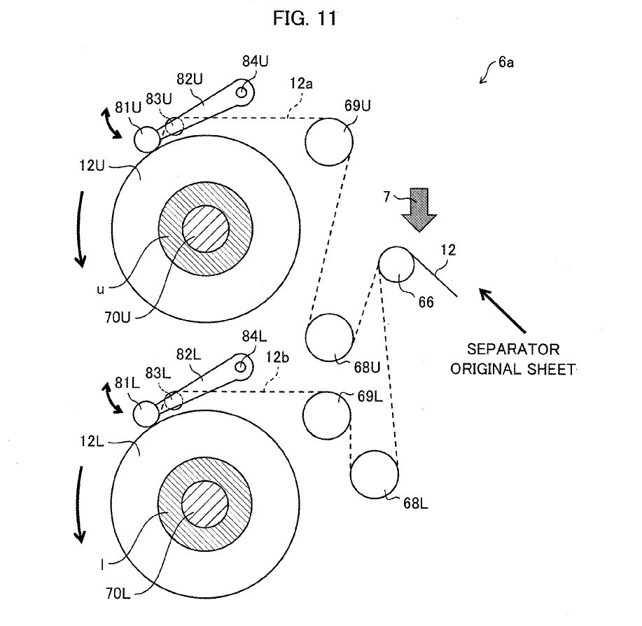

FIG. 11 is an enlarged view illustrating a part of a slitting apparatus 6a in accordance with the present embodiment, as with FIG. 6. The slitting apparatus 6a includes rollers 66, 68U, 68L, 69U, 69L, a first touch roller 81U, a second touch roller 81L, a first arm 82U, a second arm 82L, a first take-up roller 70U, a second take-up roller 70L, and a plurality of cutting devices 7. A configuration relating to the first arm 82U and the second arm 82L is identical with that in Embodiment 1.

A conveyed original sheet of the separator 12 is, for example, slit into a plurality of slit separators (first separator 12a and second separator 12b) by the plurality of cutting devices 7 (slitting section) on an upstream side of the roller 66. The first separator 12a and the second separator 12b are to be conveyed in different directions by the roller 66. The first separator 12a is conveyed to the first take-up assisting roller 83U via the rollers 68U and 69U. The second separator 12b is conveyed to the second take-up assisting roller 83L via the rollers 68L and 69L.

### Modification Example

In the above described embodiments, each of the first take-up assisting roller 83U and the second take-up assisting roller 83L can be a concave roller such as a reverse crown roller. The concave roller is a roller having a shape in which an outer diameter of its center part in the transverse direction (TD) is smaller than outer diameters of its both end parts. From this, a separator that is conveyed is stretched at the both end parts of the rotating concave roller, and it is thus possible to stretch a wrinkle which has been caused in the separator during the conveying. It is necessary to take up the separator while a wrinkle is stretched, and it is therefore preferable that rollers (first take-up assisting roller 83U and second take-up assisting roller 83L) immediately before the first touch roller 81U and the second touch roller 81L are respective concave rollers. The concave roller can have a curved shape in which the outer diameter gradually becomes larger toward the both end parts, a straight line shape, or a shape in which the outer diameter becomes larger step-by-step toward the both end parts.

Note, however, that it is preferable to provide one (1) concave first take-up assisting roller 83U for one (1) first separator 12a and one (1) core u. As illustrated in FIG. 9, in a case where a plurality of sets of the first separator 12a and the core u are arranged side by side, a plurality of concave first take-up assisting rollers 83U can be provided for the respective plurality of sets. Note that the plurality of first take-up assisting rollers 83U can include both a concave roller and a columnar roller that is not concave but is flat. Alternatively, in a case where one (1) first take-up assisting roller 83U conveys a plurality of first separators 12a, a surface of the first take-up assisting roller 83U can have a plurality of concave portions at positions corresponding to the respective plurality of first separators 12a. The same applies to the second take-up assisting roller 83L.

Moreover, in the above described embodiments, a material of the surface of each of the rollers can be an arbitrary one. For example, it is possible to employ a configuration in which a surface of the touch roller is made of resin and a surface of the take-up assisting roller which is immediately before the touch roller is made of metal.

In a case where the surface of the touch roller is made of resin, it is possible to ease collision between the separator roll and the touch roller caused by vibration in winding, and it is therefore possible to inhibit a wrinkle (in particular, a step-like wrinkle) caused by the collision. In a case where the surface of the take-up assisting roller is made of metal, it is possible to reduce abrasion of the take-up assisting roller, and it is therefore possible to inhibit a wrinkle or misaligned winding which is caused due to the abrasion. In particular, in a case where the take-up assisting roller makes contact with a heat-resistant layer which is of a separator and contains a filler, the abrasion becomes notable, and it is therefore preferable that the surface of the take-up assisting roller is made of metal.

[Main Points]

The slitting apparatus in accordance with an aspect of the present invention includes a slitting section for slitting an original sheet of a battery separator in a lengthwise direction so as to divide the original sheet into a plurality of separators; a take-up section for winding one of the plurality of separators on a core; a touch roller whose position is changed in accordance with a change in outer diameter of a separator roll so as to press the one of the plurality of separators onto a take-up surface of the separator roll which has been formed on the core; and a take-up assisting roller for conveying the one of the plurality of separators immediately before the touch roller, a position of the take-up assisting roller being changed in accordance with positional change of the touch roller.

According to the configuration, it is possible to reduce a change in positional relation between the touch roller and the take-up assisting roller immediately before the touch roller, which change is caused by a change in outer diameter of the separator roll. From this, it is possible to obtain a uniform wound state of the separator roll, regardless of the change in outer diameter of the separator roll. It is therefore possible to inhibit a wrinkle or misaligned winding caused in the separator roll.

A distance between the touch roller and the take-up assisting roller can be constant, regardless of a change in outer diameter of the separator roll.

According to the configuration, it is possible to reduce a change in position at which the separator makes contact with the touch roller, which change is caused by a change in outer diameter of the separator roll. Therefore, it is possible to obtain a uniform wound state in the separator roll.

It is possible to employ a configuration in which the slitting apparatus includes a plurality of roller attaching sections to any of which the take-up assisting roller is attached, the plurality of roller attaching sections being provided so that a distance between the touch roller and the take-up assisting roller is selectable from a plurality of distances.

According to the configuration, the user can adjust a wound state of the separator roll by changing the distance between the touch roller and the take-up assisting roller.

It is possible that the take-up section includes one (1) rotation shaft for holding a plurality of cores on which the respective plurality of separators are wound, each of the plurality of cores being the core; and the slitting apparatus includes, for the one (1) rotation shaft, a plurality of touch rollers each of which is the touch roller, positions of the plurality of touch rollers being separately changed in accordance with changes in outer diameter of a plurality of separator rolls each of which is the separator roll.

According to the configuration, even in a case where the thickness of the separator original sheet is not uniform, the plurality of touch rollers whose positions are separately changed can appropriately press the respective plurality of separators onto take-up surfaces of the respective plurality of separator rolls.

It is possible to employ a configuration in which the slitting apparatus includes an arm which is provided so as to swing or is provided so that a position of the arm is changeable, the touch roller and the take-up assisting roller being fixed to the arm.

According to the configuration, it is possible to maintain a constant distance between the touch roller and the take-up assisting roller.

It is possible to employ a configuration in which the arm is rotatable around a rotation shaft; and the take-up assisting roller is provided between the touch roller and the rotation shaft of the arm.

According to the configuration, the take-up assisting roller can be efficiently provided between the touch roller and the rotation shaft of the arm, and it is therefore possible to inhibit increase in size of the apparatus.

It is possible to employ a configuration in which the one of the plurality of separators conveyed from the take-up assisting roller makes contact with the touch roller before making contact with the take-up surface.

According to the configuration, the separator is pressed onto the take-up surface while being conveyed on the touch roller (i.e., while a wrinkle is being stretched).

According to the configuration, a wrinkle of the separator can be stretched on the take-up assisting roller that is immediately before the touch roller. It is therefore possible to take up the separator in a state in which the wrinkle is stretched.

It is possible that a surface of the touch roller is made of resin; and a surface of the take-up assisting roller is made of metal.

It is possible to employ a configuration in which the one of the plurality of separators (i) passes through on a side of the take-up assisting roller which side is opposite to the separator roll, (ii) passes through between the take-up assisting roller and the touch roller, and (iii) passes through between the touch roller and the separator roll.

According to the configuration, the separator is conveyed in an S-shape route immediately before being pressed by the touch roller. From this, it is possible to take up the separator in a state in which a wrinkle is stretched.

The slitting apparatus in accordance with an aspect of the present invention includes a slitting section for slitting an original sheet of a battery separator in a lengthwise direction so as to divide the original sheet into a plurality of separators; a take-up section for winding one of the plurality of separators on a core; a touch roller whose position is changed in accordance with a change in outer diameter of a separator roll so as to press the one of the plurality of separators onto a take-up surface of the separator roll which has been formed on the core; a take-up assisting roller for conveying the one of the plurality of separators immediately before the touch roller; and a plurality of roller attaching sections to any of which the take-up assisting roller is attached, the plurality of roller attaching sections being provided so that a distance between the touch roller and the take-up assisting roller is selectable from a plurality of distances.

The slitting apparatus in accordance with an aspect of the present invention includes a slitting section for slitting an original sheet of a battery separator in a lengthwise direction so as to divide the original sheet into a plurality of separators; a take-up section having one (1) rotation shaft for holding a plurality of cores on which the respective plurality of separators are wound; and a plurality of touch rollers which are provided for the one (1) rotation shaft and whose positions are separately changed in accordance with changes in outer diameter of a plurality of separator rolls, which have been formed on the respective plurality of cores, so as to press the plurality of separators onto take-up surfaces of the respective plurality of separator rolls.

The method in accordance with an aspect of the present invention for producing a separator roll includes the steps of: (a) slitting an original sheet of a battery separator in a lengthwise direction so as to divide the original sheet into a plurality of separators; (b) winding one of the plurality of separators on a core; (c) pressing, by a touch roller, the one of the plurality of separators onto a take-up surface of a separator roll which has been formed on the core, a position of the touch roller being changed in accordance with a change in outer diameter of the separator roll; and (d) conveying, by a take-up assisting roller, the one of the plurality of separators immediately before the touch roller, a position of the take-up assisting roller being changed in accordance with positional change of the touch roller.

In the production method, a distance between the touch roller and the take-up assisting roller can be constant, regardless of a change in outer diameter of the separator roll.

In the production method, it is possible that the take-up assisting roller is attached to one of a plurality of roller attaching sections which are provided so that a distance between the touch roller and the take-up assisting roller is selectable from a plurality of distances.

In the production method, it is possible to employ a configuration in which, in the step (b), the plurality of separators are wound on respective of a plurality of cores which are held on one (1) rotation shaft, each of the plurality of cores being the core; and, in the step (c), the plurality of separators are respectively pressed by a plurality of touch rollers onto take-up surfaces of a plurality of separator rolls which have been formed on the respective plurality of cores, each of the plurality of touch rollers being the touch roller, each of the plurality of separator rolls being the separator roll, and the plurality of touch rollers being provided for the one (1) rotation shaft and positions of the plurality of touch rollers being separately changed in accordance with changes in outer diameter of the plurality of separator rolls.

In the production method, it is possible to employ a configuration in which the touch roller and the take-up assisting roller are fixed to an arm which is provided so as to swing or is provided so that a position of the arm is changeable.

In the production method, it is possible to employ a configuration in which the arm is rotatable around a rotation shaft; and the take-up assisting roller is provided between the touch roller and the rotation shaft of the arm.

In the production method, it is possible to employ a configuration in which the one of the plurality of separators conveyed from the take-up assisting roller makes contact with the touch roller before making contact with the take-up surface.

In the production method, it is possible to employ a configuration in which a surface of the touch roller is made of resin; and a surface of the take-up assisting roller is made of metal.

In the production method, it is possible to employ a configuration in which the one of the plurality of separators (i) passes through on a side of the take-up assisting roller which side is opposite to the separator roll, (ii) passes through between the take-up assisting roller and the touch roller, and (iii) passes through between the touch roller and the separator roll.

The method in accordance with an aspect of the present invention for producing a separator roll includes the steps of: (a) slitting an original sheet of a battery separator in a lengthwise direction so as to divide the original sheet into a plurality of separators; (b) winding one of the plurality of separators on a core; (c) pressing, by a touch roller, the one of the plurality of separators onto a take-up surface of a separator roll which has been formed on the core, a position of the touch roller being changed in accordance with a change in outer diameter of the separator roll; and (d) conveying, by a take-up assisting roller, the one of the plurality of separators immediately before the touch roller, the take-up assisting roller being attached to one of a plurality of roller attaching sections which are provided so that a distance between the touch roller and the take-up assisting roller is selectable from a plurality of distances.

The method in accordance with an aspect of the present invention for producing a separator roll includes the steps of: (a) slitting an original sheet of a battery separator in a lengthwise direction so as to divide the original sheet into a plurality of separators; (b) winding the plurality of separators on respective of a plurality of cores which are held on one (1) rotation shaft; and (c) pressing, by a plurality of touch rollers, the plurality of separators onto respective take-up surfaces of a plurality of separator rolls which have been formed on the respective plurality of cores, the plurality of touch rollers being provided for the one (1) rotation shaft and positions of the plurality of touch rollers being separately changed in accordance with changes in outer diameter of the plurality of separator rolls.

The present invention is not limited to the embodiments, but can be altered by a skilled person in the art within the scope of the claims. An embodiment derived from a proper combination of technical means disclosed in respective different embodiments is also encompassed in the technical scope of the present invention.

### INDUSTRIAL APPLICABILITY

The present invention can be used in a slitting apparatus, a method for producing a separator roll, and the like.

### REFERENCE SIGNS LIST

1: Lithium-ion secondary battery
4: Heat-resistant layer
5: Porous film
6, 6a: Slitting apparatus
7: Cutting device (slitting section)
12, 12a, 12b: Separator, first and second separators
12A through 12C, 12U, 12L: First and second separator rolls
70U, 70L: First and second take-up rollers (take-up section, rotation shaft)
81A through 81C, 81U, 81L: First and second touch rollers
82A through 82C, 82U, 82L: First and second arms
83A through 83E, 83U, 83L: First and second take-up assisting rollers
85a through 85f: Roller attaching section
1, u: Core

1. A slitting apparatus comprising:
a slitting section for slitting an original sheet of a battery separator in a lengthwise direction so as to divide the original sheet into a plurality of separators;
a take-up section for winding one of the plurality of separators on a core;
a touch roller whose position is changed in accordance with a change in outer diameter of a separator roll so as to press the one of the plurality of separators onto a take-up surface of the separator roll which has been formed on the core; and
a take-up assisting roller for conveying the one of the plurality of separators immediately before the touch roller, a position of the take-up assisting roller being changed in accordance with positional change of the touch roller.

2. The slitting apparatus as set forth in claim 1, wherein a distance between the touch roller and the take-up assisting roller is constant, regardless of a change in outer diameter of the separator roll.

3. The slitting apparatus as set forth in claim 1, further comprising:
a roller attaching section to which the take-up assisting roller is attached, the roller attaching section being provided so that a distance between the touch roller and the take-up assisting roller is selectable from a plurality of distances.

4. The slitting apparatus as set forth in claim 1, wherein:
the take-up section includes one (1) rotation shaft for holding a plurality of cores on which the respective plurality of separators are wound, each of the plurality of cores being the core; and
said slitting apparatus includes, for the one (1) rotation shaft, a plurality of touch rollers each of which is the touch roller, positions of the plurality of touch rollers being separately changed in accordance with changes in outer diameter of a plurality of separator rolls each of which is the separator roll.

5. The slitting apparatus as set forth in claim 1, further comprising:
an arm which is provided so as to swing or is provided so that a position of the arm is changeable,
the touch roller and the take-up assisting roller being fixed to the arm.

6. The slitting apparatus as set forth in claim 5, wherein:
the arm is rotatable around a rotation shaft; and
the take-up assisting roller is provided between the touch roller and the rotation shaft of the arm.

7. The slitting apparatus as set forth in claim 1, wherein:
the one of the plurality of separators conveyed from the take-up assisting roller makes contact with the touch roller before making contact with the take-up surface.

8. The slitting apparatus as set forth in claim 1, wherein:
a surface of the touch roller is made of resin; and
a surface of the take-up assisting roller is made of metal.

9. The slitting apparatus as set forth in claim 1, wherein:
the one of the plurality of separators (i) passes through on a side of the take-up assisting roller which side is opposite to the separator roll, (ii) passes through between the take-up assisting roller and the touch roller, and (iii) passes through between the touch roller and the separator roll.

10. A slitting apparatus comprising:
a slitting section for slitting an original sheet of a battery separator in a lengthwise direction so as to divide the original sheet into a plurality of separators;
a take-up section for winding one of the plurality of separators on a core;
a touch roller whose position is changed in accordance with a change in outer diameter of a separator roll so as to press the one of the plurality of separators onto a take-up surface of the separator roll which has been formed on the core;
a take-up assisting roller for conveying the one of the plurality of separators immediately before the touch roller; and
a roller attaching section to which the take-up assisting roller is attached, the roller attaching section being provided so that a distance between the touch roller and the take-up assisting roller is selectable from a plurality of distances.

11. A slitting apparatus comprising:
a slitting section for slitting an original sheet of a battery separator in a lengthwise direction so as to divide the original sheet into a plurality of separators;
a take-up section having one (1) rotation shaft for holding a plurality of cores on which the respective plurality of separators are wound; and
a plurality of touch rollers which are provided for the one (1) rotation shaft and whose positions are separately changed in accordance with changes in outer diameter of a plurality of separator rolls, which have been formed on the respective plurality of cores, so as to press the plurality of separators onto take-up surfaces of the respective plurality of separator rolls.

12. A method for producing a separator roll, said method comprising the steps of:
(a) slitting an original sheet of a battery separator in a lengthwise direction so as to divide the original sheet into a plurality of separators;
(b) winding one of the plurality of separators on a core;
(c) pressing, by a touch roller, the one of the plurality of separators onto a take-up surface of a separator roll which has been formed on the core, a position of the touch roller being changed in accordance with a change in outer diameter of the separator roll; and
(d) conveying, by a take-up assisting roller, the one of the plurality of separators immediately before the touch roller, a position of the take-up assisting roller being changed in accordance with positional change of the touch roller.

13. The method as set forth in claim 12, wherein a distance between the touch roller and the take-up assisting roller is constant, regardless of a change in outer diameter of the separator roll.

14. The method as set forth in claim 12, wherein:
the take-up assisting roller is attached to a roller attaching section which is provided so that a distance between the touch roller and the take-up assisting roller is selectable from a plurality of distances.

15. The method as set forth in claim 12, wherein:
in the step (b), the plurality of separators are wound on respective of a plurality of cores which are held on one (1) rotation shaft, each of the plurality of cores being the core; and
in the step (c), the plurality of separators are respectively pressed by a plurality of touch rollers onto take-up surfaces of a plurality of separator rolls which have been formed on the respective plurality of cores, each of the plurality of touch rollers being the touch roller, each of the plurality of separator rolls being the separator roll, and the plurality of touch rollers being provided for the one (1) rotation shaft and positions of the plurality of touch rollers being separately changed in accordance with changes in outer diameter of the plurality of separator rolls.

16. The method as set forth in claim 12, wherein the touch roller and the take-up assisting roller are fixed to an arm which is provided so as to swing or is provided so that a position of the arm is changeable.

17. The method as set forth in claim 16, wherein:
the arm is rotatable around a rotation shaft; and
the take-up assisting roller is provided between the touch roller and the rotation shaft of the arm.

18. The method as set forth in claim 12, wherein:
the one of the plurality of separators conveyed from the take-up assisting roller makes contact with the touch roller before making contact with the take-up surface.

19. The method as set forth in claim 12, wherein:
a surface of the touch roller is made of resin; and
a surface of the take-up assisting roller is made of metal.

20. The method as set forth in claim 12, wherein:
the one of the plurality of separators (i) passes through on a side of the take-up assisting roller which side is opposite to the separator roll, (ii) passes through between the take-up assisting roller and the touch roller, and (iii) passes through between the touch roller and the separator roll.

21. A method for producing a separator roll, said method comprising the steps of:
(a) slitting an original sheet of a battery separator in a lengthwise direction so as to divide the original sheet into a plurality of separators;
(b) winding one of the plurality of separators on a core;
(c) pressing, by a touch roller, the one of the plurality of separators onto a take-up surface of a separator roll which has been formed on the core, a position of the touch roller being changed in accordance with a change in outer diameter of the separator roll; and
(d) conveying, by a take-up assisting roller, the one of the plurality of separators immediately before the touch roller,
the take-up assisting roller being attached to a roller attaching section which is provided so that a distance between the touch roller and the take-up assisting roller is selectable from a plurality of distances.

22. A method for producing a separator roll, said method comprising the steps of:
(a) slitting an original sheet of a battery separator in a lengthwise direction so as to divide the original sheet into a plurality of separators;
(b) winding the plurality of separators on respective of a plurality of cores which are held on one (1) rotation shaft; and
(c) pressing, by a plurality of touch rollers, the plurality of separators onto respective take-up surfaces of a plurality of separator rolls which have been formed on the respective plurality of cores, the plurality of touch rollers being provided for the one (1) rotation shaft and positions of the plurality of touch rollers being separately changed in accordance with changes in outer diameter of the plurality of separator rolls.
